(19) United States
(12) Patent Application Publication
(10) Pub. No.: US 2012/0140774 A1
(43) Pub. Date: Jun. 7, 2012

(54) Methods and Systems for Enterprise Network Access Point Determination

(75) Inventors: Gert Öster, Järfälla (SE); John Baldwin, Coventry (GB); Hans-Erik Van Elburg, Oosterhout (NL)

(73) Assignee: TELEFONAKTIEBOLAGET L M ERICSSON (PUBL), Stockholm (SE)

(21) Appl. No.: 13/141,513

(22) PCT Filed: Dec. 26, 2008
(86) PCT No.: PCT/IB2008/003630

§ 371 Date: Dec. 1, 2011

(51) Int. Cl. H04L 12/56; H04L 12/28

(52) U.S. Cl. 370/401

(57) ABSTRACT

Systems and methods according to these exemplary embodiments provide for methods and systems for routing communications from a serving network to an enterprise network. Access point information associated with users in the enterprise network is stored and accessible for use by the serving network.

### TECHNICAL FIELD

The exemplary embodiments herein generally relate to systems, devices, software, methods and, more particularly, to mechanisms and techniques for routing messages through interconnected networks to users in an enterprise.

### BACKGROUND

As technological capabilities continue to expand, the options for communications have become more varied. For example, in the last 30 or so years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at homes. This has evolved into both different standards of picture quality such as, standard definition television (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also some of these services are expected to be based on the technical capability to process and output more information.

Another related technology that impacts both the communications and entertainment industries is interconnected networks. The physical structure of these communication networks and associated communication streams have also evolved to handle an increased flow of data. Servers have more memory than ever before, communications links exist that have a higher bandwidth than in the past, processors are faster and more capable and protocols exist to take advantage of these elements. These communications networks can be any network or networks linking users and businesses. As consumers' usage of these networks grows, this growth can fuel the creation of more networks, which can be interconnected, for providing services. These services may include, for example, Internet Protocol television (IPTV, referring to systems or services that deliver television programs over a network using IP data packets), Internet radio, video on demand (VoD), live events, voice over IP (VoIP), and other web related services received singly or bundled together. Also, along with the changes in technology and the growth of services, new networks and communication protocols, e.g., Internet Protocol Multimedia Subsystem (IMS) networks and session initiation protocol (SIP), have been developed to improve and implement the usage of these various services.

A characteristic of telecommunications networks is that many such networks exists (each run by a network operator) and these networks are interconnected. The interconnection may be direct between two networks, or may be indirect via one or more interconnect or transit networks. Each of these network operators will have commercial service level agreements (SLAs) with its interconnect partners and will have equipment to make routing decisions based upon 1) the destination user address and 2) the commercial SLAs. The destination user address identifies a user and this user is served by a network operator. The destination user address may be a telephone number or some email-style uniform resource identifier (URI). In the latter case, the destination user address may not readily identify the serving network operator—e.g. john@bank.com, john@baldwin.org. This presents a difficulty to the originating network operator to know how to route the request.

Accordingly, it would be desirable to provide devices, systems and methods for improving communications over a variety of interconnected networks.

### SUMMARY

Systems and methods according to exemplary embodiments address this need and others by providing systems and methods for improving communications flow over a variety of interconnected networks.

According to one exemplary embodiment, a method for routing communications from a serving network to an enterprise network includes: transmitting, from the serving network, a query message which includes a destination user address; receiving, at the serving network, a response message which includes internal message routing information and access point identifying information associated with the destination user address; embedding, at the serving network, the access point information into a message; and transmitting, by the serving network, the message based on the internal message routing information toward an access point associated with the access point identification information.

According to another exemplary embodiment, a method for routing communications at a communications node includes: storing a plurality of destination user addresses, wherein each destination user address is associated with an access point and internal routing information; receiving a query message which includes a destination user address; performing a lookup with the destination user address to determine a corresponding access point and internal message routing information; and transmitting a response message which includes information based upon the corresponding access point and the internal message routing information identified in the lookup.

According to yet another exemplary embodiment, a communications node includes: a memory for storing destination user addresses, access point information and internal message routing information; a communications interface for transmitting and receiving messages associated with the destination user addresses, access point information and internal message routing information; and a processor for performing a lookup when a query including the destination address is received, wherein the lookup results in return of the access point information and the internal message routing information, further wherein the communications interface transmits a response message including the access point information and the internal message routing information.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows communications transiting over interconnected networks according to exemplary embodiments;

FIG. 2 illustrates interconnecting Internet Protocol Multimedia Subsystem (IMS) networks;

FIG. 3(a) shows a European Telecommunications Standards Institution (ETSI) ETSI TS 182 025 architecture for a subscription interconnect;

FIG. 3(b) shows an ETSI TS 182 025 architecture for a peering interconnect;

FIG. 4 depicts interconnected private networks according to exemplary embodiments;

FIG. 5 is a signaling diagram for routing message traffic according to exemplary embodiments;

FIG. 6 shows a communications architecture where an enterprise is associated with two serving operator networks according to exemplary embodiments;

FIG. 7 shows a signaling diagram including a response with multiple serving operator choices for routing message traffic according to exemplary embodiments;

FIG. 8 shows elements of an IMS network according to exemplary embodiments;

FIG. 9 illustrates using an access point table according to exemplary embodiments;

FIG. 10 depicts message traffic delivery based upon interconnection type according to exemplary embodiments;

FIG. 11 shows a signaling diagram for the delivery of message traffic from a serving network to a user at an enterprise according to exemplary embodiments;

FIG. 12 is a communications node according to exemplary embodiments;

FIG. 13 depicts a method flowchart for routing communications from a serving network according to exemplary embodiments; and

FIG. 14 shows another method flowchart for routing communications at a communications node according to exemplary embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of communication networks described below. However, the embodiments to be discussed next are not limited to these systems but may be applied to other existing communication systems.

Reference throughout the specification to “one embodiment” or “an embodiment” or “exemplary embodiments” means that a particular feature, structure, or characteristic described in connection with an embodiment is included in at least one embodiment of the present invention. Thus, the appearance of the phrases “in one embodiment” or “in an embodiment” or “in exemplary embodiments” in various places throughout the specification are not necessarily all referring to the same embodiment. Further, the particular features, structures or characteristics may be combined in any suitable manner in one or more embodiments.

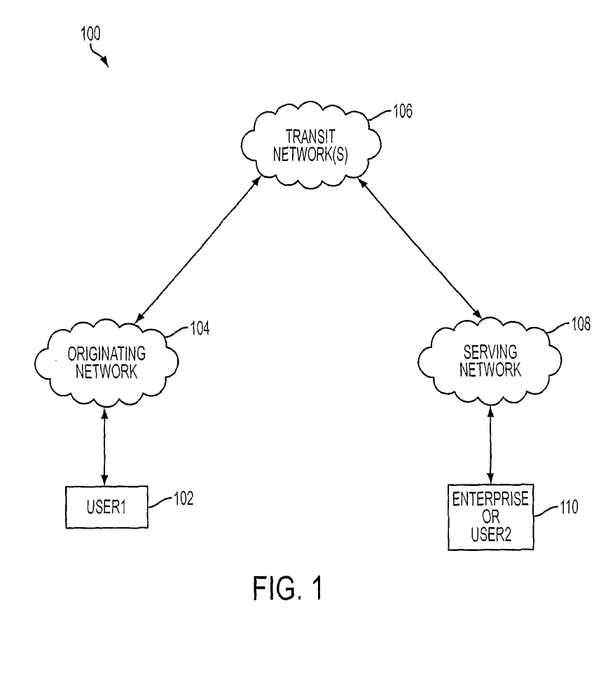

As mentioned above, it is desirable to provide devices, systems and methods for improving communications over a variety of interconnected networks. The following exemplary embodiments describe routing messages, e.g., session initiation protocol (SIP) messages, over various interconnected networks, e.g., networks which use Internet Protocol Multimedia Subsystem (IMS). In order to provide some context for this discussion, an exemplary communications framework is shown in FIG. 1.

According to exemplary embodiments, FIG. 1 shows a user communicating to another user (or a resource within an enterprise, e.g., a device or person within a company) with the communication transiting over multiple, interconnected networks. More specifically, the exemplary communications framework 100 shows User1 102 communicating to Enterprise/User2 110 with, for example, devices capable of transmitting SIP messages, e.g., mobile phones and computers. These SIP messages are first transmitted through the originating network 104, then through one or more transit networks 106 and then through the serving network 108. However, varying proposals exist regarding the domain name system (DNS) conventions used to address such messages in these varying networks, e.g., the various public telecommunication networks, and interconnecting networks, which in turn leads to challenges for the correct and efficient delivery of these SIP messages. Additionally, as used herein, “originating network”, “originating operator network” and “originating network operator” refer to the originating network that a device is connected to which initiates a call. Also, as used herein, “serving network”, “serving operator network” and “serving network operator” refer to the network which serves the end user and delivers the call to a residential user or to a user within an enterprise.

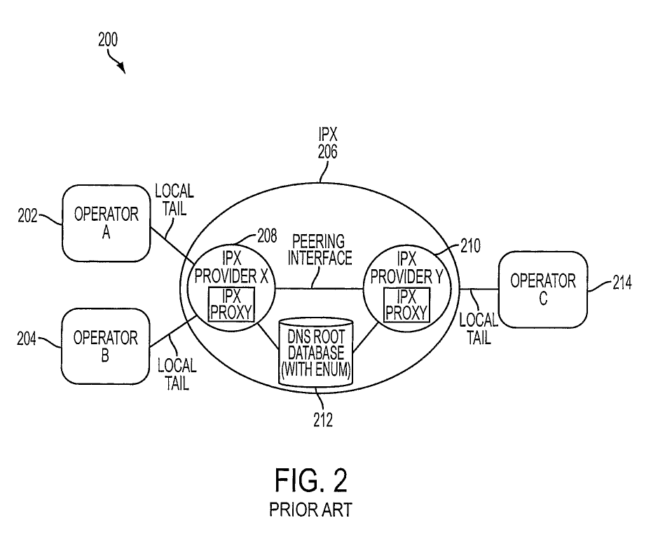

One possible framework for interconnecting IMS networks is proposed by the Global System for Mobile Communications Association (GSMA) as shown in FIG. 2. This global inter-service provider IP backbone is typically referred to as the Internetwork Packet Exchange (IPX) and is described in GSMA IR.34. Included in this framework is Operator A 202 and Operator B 204, both of which are connected to IPX Provider X 208, and Operator C 214 which is connected to IPX Provider Y 210. IPX Provider X 208 and IPX Provider Y 210 are part of the IPX 206 and are in communication with a domain name system (DNS) root database 212 with Electronic Number Mapping System (ENUM). A purpose of the IPX 206 is to facilitate interconnection between service providers according to agreed inter-operable service definitions and commercial agreements, e.g., service level agreements (SLAs). To facilitate this, the IPX 206 builds upon and extends the architecture of the general packet radio service (GPRS) roaming exchange (GRX) by introducing multiple stakeholders to this communications framework. These stakeholders can include fixed network operators, Internet service providers and application service providers. IPX 206 is expected to have its own DNS infrastructure, relevant information of which can be stored in the DNS root database 212, for routing of message traffic. The GSMA defined DNS naming convention for operators connected to the IPX is based upon using the mobile network code (MNC) and the mobile country code (MCC). An example of a unique identifier for a SIP message based upon the GSMA proposal would be as follows:

sip:+447703123456@mnc001.mcc234.3gppnetworks.org

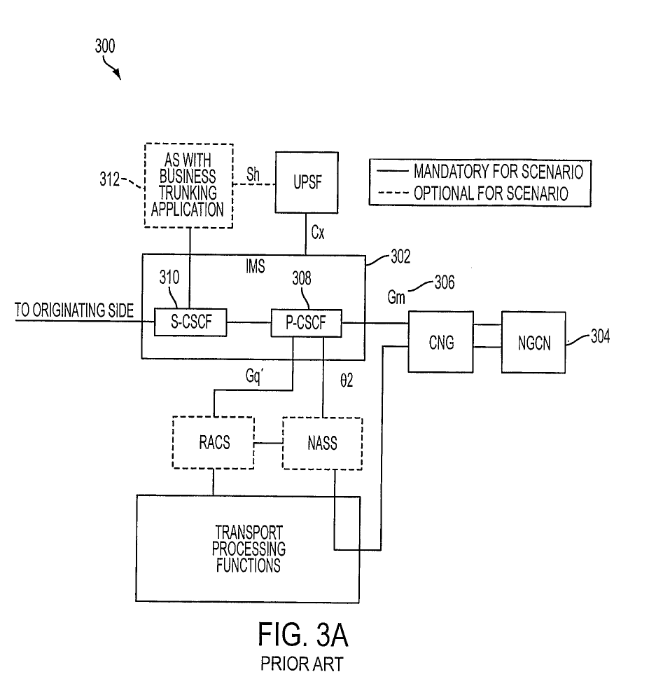

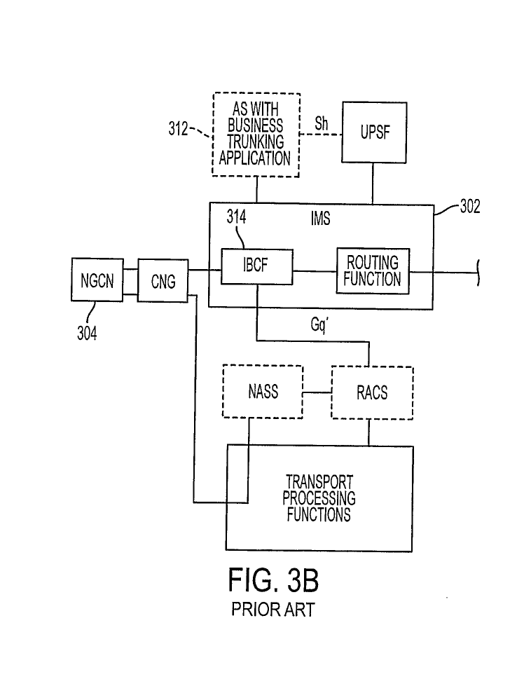

Another proposal for the interconnection of networks has been made by the European Telecommunications Standards Institution (ETSI) Telecommunications and Internet Services and Protocols for Advanced Networks (TISPAN) next generation network (NGN) release 2. More specifically, as shown in FIG. 3(a), ETSI TS 182 025 provides an architecture 300 for how a business trunking next generation corporate network (NGCN) 304 can be connected to the serving operator's IMS network 302 on a subscription basis. The Gm reference point 306 indicates the boundary between the serving operator's IMS network 302 and the corporate network. In the case of the subscription interconnect, the NGCN 304 is realized as a single user within the IMS context and the NGCN 304 is expected to perform user registration with the serving operator's IMS network 302. The serving operator's IMS network 302 can then provide services to the user through the call session control function (CSCFs), e.g., serving-CSCF (S-CSCF) 310 and proxy-CSCF (P-CSCF) 308, and an application server (AS) 312.

ETSI TS 182 025 allows for and identifies variations of the architecture shown in FIG. 3(a) for other business scenarios. In one case, as shown in FIG. 3(b), a business trunking NGCN is connected to the serving operator's IMS network 302 by a peering arrangement instead of by a subscription arrangement. In this case of a peering interconnection, there is no user within the serving operator's IMS network 302 for the NGCN 304. Instead, the NGCN 304 is represented in the serving operator's IMS network 302 by an Interconnect Border Control Function (IBCF) 314 with session information being routed through the IBCF 314.

In another case, called a Hosted Enterprise Service NGCN, each user within the NGCN 304 is realized as a single user within the serving operator's IMS network 302 and as such, each user within the NGCN 304 is expected to perform user registration with the serving operator's IMS network 302 and have services routed through the CSCFs. Also, for a large enterprise's network (or networks), there may be several instances of these connections between NGCN 304 sites and the serving operator network (or various serving operator networks) where these instances of connections may be a mixture of the three cases described above.

In each of these cases described above, using the TISPAN architecture, SIP messages can be communicated which allows a user to be addressed by a Uniform Resource Identifier (URI) of the form sip:user@domain as described in request for comments (RFC) 3261. In the case of an enterprise, e.g., a corporation, the URI could be derived from an email address and might appear as, for example, sip:john@enterprise.com or it could be derived from an Internet Protocol (IP)—Private Branch eXchange (PBX) and might appear as, for example, sip:8501234@enterprise.com; user=phone. Other allowable options include a residential user, e.g., sip:john@baldwin.org, or user-friendly operator names, e.g., sip:john@telia.se.

In the context of the proposed network architectures defined by GSMA and TISPAN, the existing standards and solutions are not definitive regarding how an originating operator can route a session addressed to a SIP URI of the forms shown above based on RFC 3261. In this area, the standards make a general reference to the use of DNS for routing sessions addressed to SIP URIs which is insufficient for large scale deployments for various reasons. For example, when multiple networks are involved, each network may have an internal DNS as well as being connected to a shared DNS such as the one proposed for IPX. However, the various standards do not describe how these different DNSs are to be set up and used. To further complicate the matter, considering that there are tens of millions of fully qualified domain names (FQDNs) on the public internet, scalability is factor since it is expected that the overall quantity of unique addresses could become similar in the interconnected networks. This can create challenges for routing traffic, e.g., SIP traffic, over multiple interconnected networks.

Additionally, operators often wish to make routing decisions based upon knowledge of their interconnects to other public networks as well as interconnect agreements to these network operators. This information is not always completely supplied by their local DNS servers and associated infrastructure. For many SIP URIs the serving network operator is not easily derived from the URI. For example, the serving network operator is not shown in SIP URIs such as sip:john@enterprise.com or sip:john@baldwin.org or john@brand_name.com. So when there are multiple ways to route a message to a particular operator, the decision on which interconnect option an originating operator uses can typically only be made based upon knowledge of the operator serving the enterprise or residential user. Also the existing charging models for telephony sessions are based partly upon geographic positions of the calling and called users, and often are also partly based upon the operators who serve the calling and called users. In other words, the operators typically want to make charging decisions based upon information about the terminating operator which is not shown in such SIP URIs as sip:john@enterprise.com or sip:john@baldwin.org. Accordingly, exemplary embodiments described below provide addressing and routing mechanisms that allow sessions addressed to SIP URIs to be routed across multiple networks to the correct destination.

As described above, the general context for these exemplary embodiments includes telephony over operator networks including various telecommunication networks and serving networks. However it will be appreciated that the present invention is not limited to telephony, but can be used to route messages of any type. These networks will typically have various potential communication paths and IBCFs which separate the various networks. Additionally, it is expected that service level agreements (SLAs) will be created detailing the necessary details for forwarding communications between these various networks so that the message traffic can reach the desired endpoint. Some of the details can include, Quality of Service requirements, costs, and addressing conventions, e.g., an agreed upon format to be used by the networks for identifying themselves.

According to exemplary embodiments, a solution for determining (e.g., by an originating network) the desired routing path of a request or message includes the originating network querying a database and receiving a response which is used to determine the message routing. For example, suppose that an originating network receives a SIP message from a user which includes a destination user address, e.g., a SIP URI of sip:john@bank.com. The originating network, acting as an originating network, does not know what serving network provides service to bank.com and therefore does not know where to send the message. The originating network then queries a serving operator database (which could include a master DNS database) with, for example, some type of a destination identifier, e.g., sip:john@bank.com, bank.com or any other type of destination identifier associated with a destination user address, and receives a response which includes information which identifies the serving network, e.g., the FQDN of the serving network or other agreed upon identifier.

According to exemplary embodiments, this serving operator database can include significantly more information than a typical network level DNS server, e.g., the serving operator database could include information for all of the FQDNs and various networks that are interconnected. By way of contrast, the network level DNS typically only holds records for the networks operators ingress points from the shared interconnect, and are run by the various operators or groups such as IPX. Thus the network level DNSs discussed herein are typically used on a per network basis to translate between domain names and IP addresses for a single operator network, whereas the serving operator database discussed herein is used, among other things, to identify serving networks associated with particular messages. Upon receiving data from a serving operator database, the originating network then determines the routing path, for example, based upon any, some, or all of the following: an in place SLA between the various networks, cost and traffic management considerations. The originating network then transmits the message towards the serving network, and includes both the destination user address and information to identify the serving operator. This use of both the destination user address and information to identify the serving operator is an example of bi-level addressing.

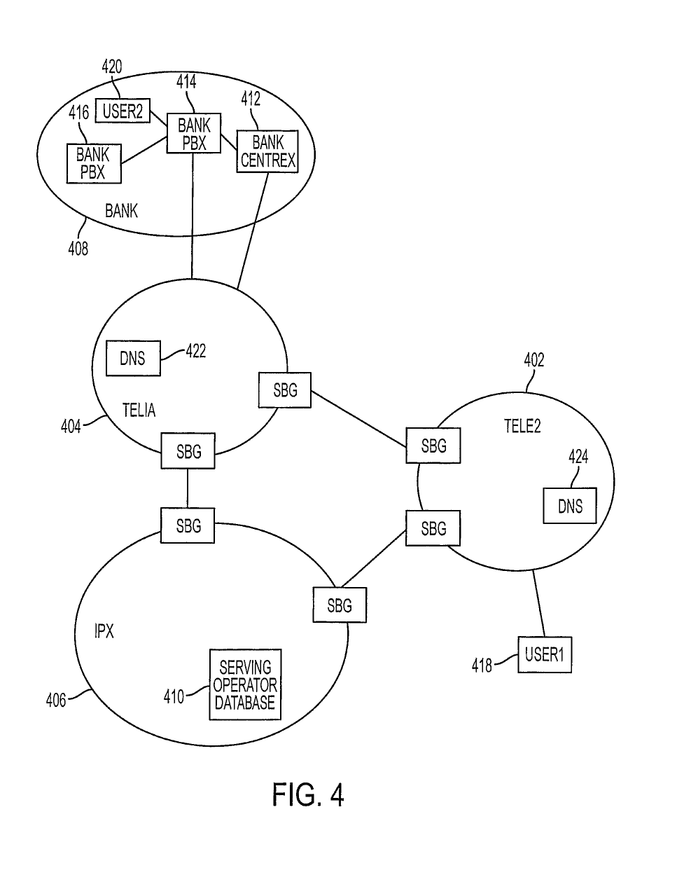

According to exemplary embodiments, various interconnected networks capable of routing communications to an enterprise (or enterprises) and individual users are shown in FIG. 4. This exemplary communications framework includes two operator networks Tele2 402 and Telia 404, IPX 406 and an enterprise's network Bank 408. The session border gateways (SBGs) are typically the access points which can also act as a firewall for communications entering and leaving the various operator networks and the IPX 406. Additionally, the operator networks Tele2 402 and Telia 404 each have their own network level DNS server 422 and 424 (or equivalent) which, at a minimum, has locally stored domain information. The serving operator database 410 includes DNS information for all of the networks associated with the IPX 406. While located in the IPX 406 in this example, the serving operator database 410 can reside anywhere that is connected and accessible to the operator networks, e.g., a third party location. The DNS information stored in the serving operator database 410 can include, for example, information describing residences and enterprises serviced by each network as reported to the serving operator database 410 by the networks, e.g., Tele2 402 and Telia 404.

The enterprise network Bank 408 includes a Bank Centrex 412 and two Bank PBXs 414 and 416 which represent where various resources and individuals are addressable. User1 418 represents a user that has service provided by Tele2 and User2 420 represents a user working for Bank 408 that is known to be associated with Bank PBX 414. Bank Centrex 412 is considered herein to be a virtual PBX. Virtual PBXs are typically associated with smaller remote business sites. For the purposes of the exemplary embodiments described herein, serving networks treat both regular and virtual PBXs similarly for the delivery of calls and messages to the end user, i.e., the exemplary embodiments described herein are not constrained by the use of either a regular or a virtual PBX.

According to exemplary embodiments described above, the serving operator database 410 includes information associated with both destination identifiers associated with users and information about their respective serving operator networks. The serving operator database 410 is able to use this information to perform a mapping between these sets of information. Additionally, this information can be in various forms. For example, general domain names, e.g., ericsson.com, telia.se and baldwin.org, can be used as well as structured telecommunication names, e.g., mnc001.mcc234, can be used for identifying various networks and users. Additionally the serving operator database 410 can perform mapping between both general domain names and structured identifiers which use the mnc and mcc.

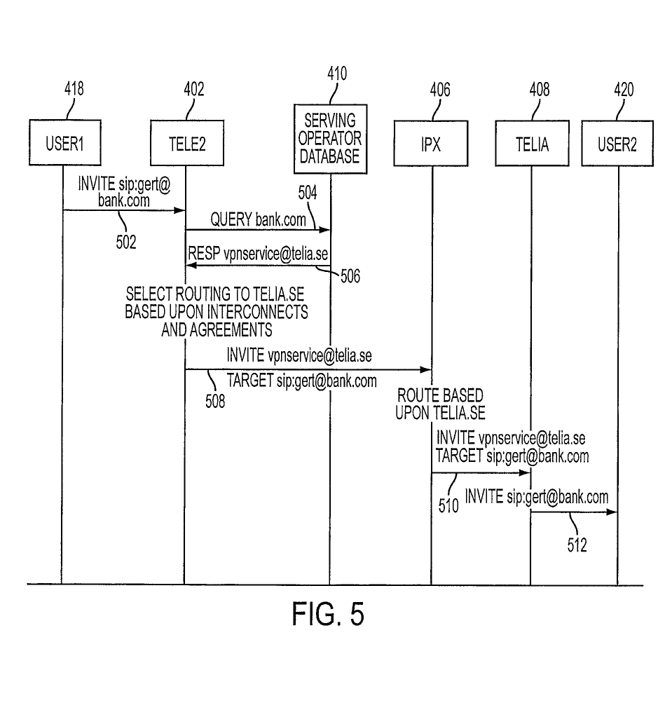

According to exemplary embodiments, message routing, e.g., calls, over the communications networks shown in FIG. 4, will now be described with respect to the signaling diagram shown in FIG. 5. Initially, User1 418 sends a message INVITE sip:gert@bank.com 502 to Tele2 402 which acts as the originating operator network. Tele2 402 does not know what network provides service to bank.com, and as such, transmits a query message 504 which includes “bank.com” (or a translated version thereof) to serving operator database 410. The serving operator database 410 performs a lookup and finds that “bank.com” is provided service by the network Telia2 404 and transmits, as part of response message 506, “vpnservice@telia.se”. Tele2 402 uses this information and determines the routing path based upon interconnects and agreements, e.g., the SLA between Tele2 402 and Telia 404.

As shown in FIG. 4, Tele2 402 is connected to Telia 404 through both a direct connection and through the IPX 406. In this case Tele2 402 chooses to route the traffic through IPX 406 as shown by message 508 which includes “INVITE vpnservice@telia.se Target sip:gert@bank.com”. IPX 406 sees in the received message 508 “telia.se” and routes the message 510 to Telia 404. Telia 404 then sends the message 512, which includes “INVITE sip:gert@bank.com, to User2 420.

As shown above, the above described routing information includes both the destination address and information which describes the network that provides service to the destination, e.g., a user or an enterprise. The latter information being made available to the originating network via the response to its query to serving operator database 410. According to exemplary embodiments, the routing information can be embedded in the SIP messages in various ways. As will be appreciated by those skilled in the art, SIP messages can include both a Request URI and a Target URI header. According to one exemplary embodiment, the serving operator identity, e.g., telia.se, can be put in the Request URI and the original SIP URI of the destination, e.g., gert@bank.com, can be put in the Target URI header of the SIP message. When the call arrives at the serving operator network, the serving operator promotes the Target URI back to the Request URI for delivery of the call on to the NGCN 304.

According to another exemplary embodiment, the serving operator identity can be appended to the Request URI, e.g., sip:john@enterprise.com.marker.mnc123.mcc234.3gppnetworks.org. Alternatively, new parameters can be put onto the SIP Request URI. For example, the serving operator can be added as a parameter on the SIP Request URI, e.g., sip:john@enterprise.com; so=mnc123.mcc234.3gppnetworks.org. According to yet another exemplary embodiment, the required serving operator information can be carried by extending other existing parameters such as the routing number (RN) or the trunk group parameter (TRGP) in a fashion similar to that described above for appending the information to the Request URI.

According to the exemplary embodiments described above, carrying both the original SIP URI and the identity of the serving operator in SIP messages allows the originating network and the transit/interconnect networks to route the messages based upon the serving operator identification information which was obtained by a central serving operator database 410. Therefore, the transit/interconnect networks do not typically need to know information about the enterprise or residential FQDNs nor do they need to query the serving operator database 410 since the serving operator network routing information is provided as part of the normal routing information for the SIP message that the transit/interconnect network knows and is able to read.

According to one exemplary embodiment, the various networks through which messages can travel each typically use separate local IP addresses internally. Therefore, traditional DNS query for IP address and routing using IP addresses is not typically used to route from the originating operator network to the serving network and on to the destination. Additionally, routing by IP addresses is not typically preferred because routing by IP address can be considered to be automatic routing which takes selection of the route used out of the control of the originating network. This does not allow the originating operator network to have control of the path and could lead to issues with SLAs as well as not being optimal for revenue.

### Multiple Instances of Serving Operators for an Enterprise

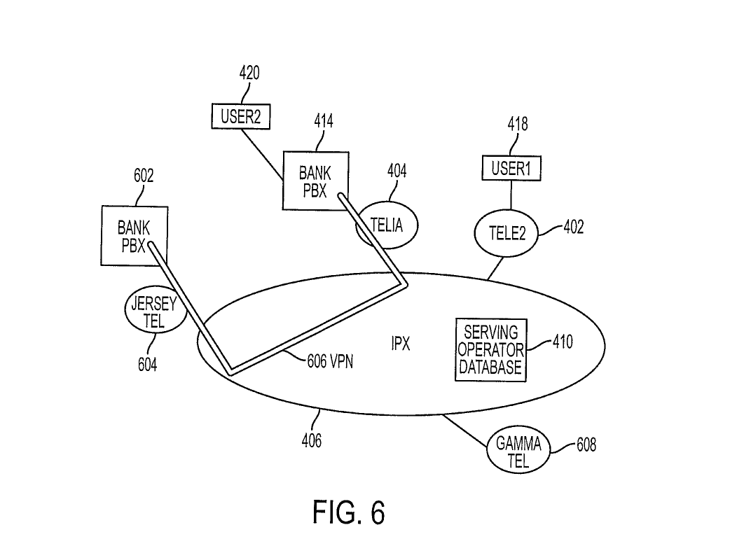

The above exemplary embodiments describe systems and methods for routing message traffic when the enterprise is served by a single serving operator network. However, for larger enterprises, there may be several instances of connections between NGCN sites and the serving operator network(s). For example, for a large enterprise network the enterprise may wish to have multiple serving operators due to widespread geographical locations of the various parts of the enterprise or for business competition reasons and the like. According to exemplary embodiments, a communications framework where an enterprise uses two different serving operator networks is described below with respect to FIG. 6.

FIG. 6 shows an exemplary communications framework which includes an IPX 406 which is connected to various operator networks, e.g., Telia 404, Tele2 402, Jersey Tel 604 and Gamma Tel 608. In this example, the IPX 406 also includes the primary DNS database 410 which includes information for mapping the FQDN of a destination to a serving network that provides service to that destination. The enterprise Bank is served by two different serving operator networks as shown with Bank PBX 414 being serviced by Telia 404 and Bank PBX 602 being serviced by Jersey Tel 604 which are connected by VPN 606. Additionally User1 418 and User2 420 are shown.

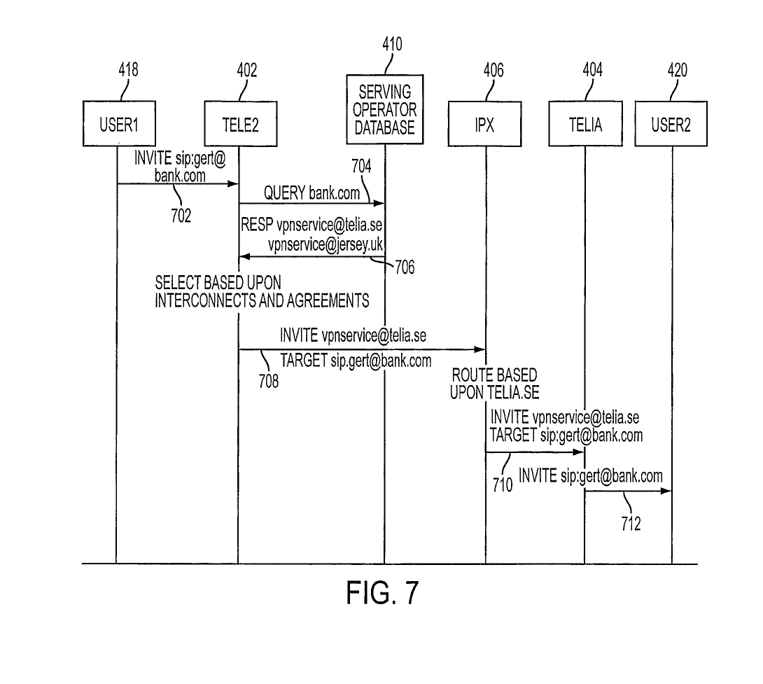

According to exemplary embodiments, a signaling flow will now be described, which uses the architecture shown in FIG. 6, for the case of having multiple serving operator networks for an enterprise as shown in FIG. 7. Initially, User1 418 sends a message 702 which includes “INVITE sip:gert@bank.com” to Tele2 402 which is acting as the originating network. Tele2 402 then sends a query message 704 which includes a destination identifier that is associated with the destination user address such as “bank.com” or “gert@bank.com” to the serving operator database 410. The serving operator database 410 performs a lookup and transmits a response message 706 which includes identification information for the two serving operator networks, e.g., vpnservice@telia.se and vpnservice@jersey.uk. Tele2 402 then decides which serving operator network to send the request to and how to route the request. These decisions can be made based on known interconnects, SLAs, geographical locations, cost and other pertinent information. Based on these decisions, Tele2 402 sends the message 708 which includes “INVITE vpnservice@telia.se and Target sip:gert@bank.com” to the IPX 406. IPX 406 sees the routing information that it needs, e.g., telia.se, and forwards the message, as shown in message 710, to Telia 404. Telia 404 then reviews the message contents and forwards them to User2 420 which is known to be gert@bank.com.

As described above, an enterprise can have various serving operator networks for different parts of the enterprise. According to exemplary embodiments, not all of the serving operator networks need to have corresponding identification or routing information stored in the serving operator database 410. Additionally, in response to the query message 704, one, some or all of the serving operator networks stored in the serving operator database 410 can be returned in the response message 706. The serving operator networks used in the response message 706 can be predetermined between the serving operator networks and the enterprise and stored accordingly in the primary DNS database 410.

According to exemplary embodiments, in the case where a wrong serving operator network receives a message, i.e., for which it determines that it does not service the destination, systems and methods can be used to further route the message to another serving operator network. In one case, a call starts in a public network by, for example, a residential user calling into an enterprise. The origination operator network selected one of the multiple serving operators (received by its query) and delivered the call to that serving operator. However, this was actually the wrong serving operator for the particular user in question. The serving operator network can query the enterprise, e.g., query a database in the enterprise for instructions on routing, and then use the bi-level addressing schemes described above to route the call to the correct serving operator network.

According to another exemplary embodiments, a call can begin in an enterprise, e.g., an enterprise user, to another enterprise user. The destination enterprise user is a part of the enterprise network that is served by a different serving network operator from the originating enterprise user. In this case, the case known as on-net calls, the call needs to be routed across the various interconnected networks to the correct serving operator network. The bilevel addressing schemes described above can also be used to forward this call to the correct serving operator.

### Domain Name Portability

According to exemplary embodiments, implementation of the above described systems and methods allow for domain name portability. Domain name portability, as used herein, describes moving the domain of a user or an enterprise from one serving operator to another serving operator with minimal overhead or effort. For example, as described above, the serving operator database 410 used in these exemplary embodiments is separate from the typical network level DNS databases 422, 424 used by each network. This serving operator database 410 is updated by each network as determined by the provider of the serving operator database 410 and each network operator, but preferably in a timely manner when changes occur, which facilitates domain name portability.

For example, assume that enterprise Bank 408 is using Telia 404 as its service provider. The enterprise Bank 408 then decides to change to Tele2 402 as its service provider, i.e., the point(s) of connection from Bank 408 to the serving network is changed to the new serving network but the internal addressing within Bank 408 does not typically change, e.g., individual SIP URIs, extensions and direct dialing inwards (DDI) numbers would remain the same. Once this change is made, then Tele2 402 updates the serving operator database 410 of the change. Changes do not typically need to be made at the lower levels of the DNS infrastructure, except in the two networks directly affected by this change. Additionally, internal changes within the network structure of Bank 408 would not, for the most part, need to be modified. This process would also be true for residential use. For example, if a user had a domain name of gert@baldwin.org and changed serving operator networks, the domain name could be ported over to the new serving operator network and still be used with a seamless transition for gert@baldwin.com.

### Enterprise Network Access Point Determination

Some of the exemplary embodiments described above include systems and methods for the routing of message traffic from an originating network over interconnected networks to a serving network. Exemplary embodiments described below include various systems and methods for delivering messages from the serving operator network to an entity within an enterprise. However, prior to discussing these exemplary embodiments, more context regarding the routing of a session from the serving network to an enterprise will first be discussed.

In the context of the proposed network architectures defined by ETSI TS 182 025, the existing standards and solutions do not describe how a serving network, which, for example, serves an enterprise network, can route a session into the correct site to an end user within the enterprise network. For example, SIP URIs such as sip:john@bank.com or sip:8501234@bank.com; user=phone do not provide enough information regarding the geographical location of the addressed user for delivery by the serving network to that entity, e.g., john, in the enterprise, e.g., bank. Additionally, such SIP URIs do not describe how the enterprise wants calls to arrive at the enterprise's network. For example, an enterprise may want all external calls (or messages) to arrive at one location, or to require that external calls be delivered to the location where the addressed user normally exists. Additionally, once the serving network has determined the appropriate enterprise network access point, the serving network typically needs to route the call across its IMS network. The call needs to traverse the correct S-CSCF 310 and AS 312 for the cases of a Hosted Enterprise user and a Business Trunking PBX that use a subscription-based interconnect, or the correct IBCF for a peering-based interconnect. Exemplary embodiments described below provide solutions for these routing issues from the serving operator network to the enterprise network for both peering interconnects and subscription interconnects.

According to exemplary embodiments, systems and methods provide addressing and routing mechanisms that allow sessions, e.g., SIP sessions, to be routed to the correct interconnection point between the serving NGN and the enterprise network and on to the correct destination user address. Additionally, these exemplary embodiments can be used to deliver calls between enterprise users located behind different interconnection points. These interconnection points between the serving NGN and the enterprise network are referred to herein as enterprise network access points. These exemplary embodiments, described below, typically apply to users within an enterprise who are part of a Business Trunking NGCN for both subscription and peering based interconnections.

According to exemplary embodiments, these methods and systems allow the enterprise to provide access, to the serving network, to information that defines for a user (as described, e.g., by the user part of a SIP URI) the associated enterprise network access point for that user and additional associated information as needed to facilitate routing. To support this, exemplary methods and systems allow for the enterprise to update this information, store policies, communicate policies and subscriber (user) moves/changes to the serving NGN. Additionally, these methods and systems allow the serving network to route the call based upon this information in the manner desired, or agreed to, by the enterprise and the serving network.

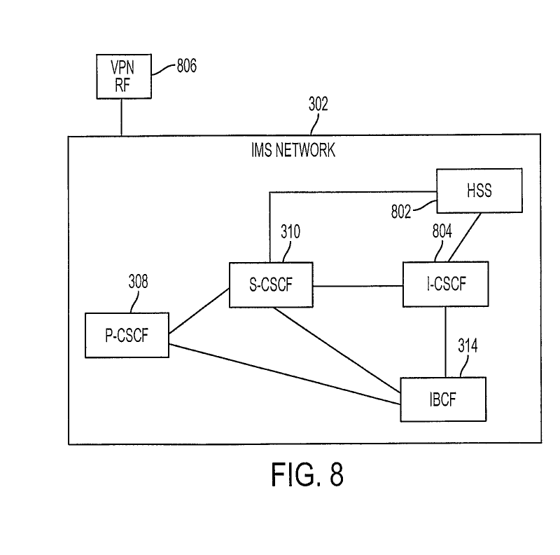

As previously described, the serving networks are typically IMS networks, although this is not required. FIGS. 3(a) and 3(b) show parts of an IMS network 302, for both peering and subscription interconnections, in communication with an NGCN 304 and an AS 312. According to exemplary embodiments, more components of an IMS network 302 are shown in FIG. 8 which can be used in routing services across the IMS network 302 to an enterprise network. These nodes of IMS network 302 include a P-CSCF 308, an S-CSCF 310 and an interrogating-CSCF (I-CSCF) 804. The P-CSCF 308 is typically the first contact point for a user in the core part of IMS network 302 and it forwards messages and requests to the desired S-CSCF 310. The S-CSCF 310 performs session control services and maintains session state information as needed. The I-CSCF 804 may perform transit routing functions and can act as the contact point within a serving operator network for connections destined to a user.

The home subscriber server (HSS) 802 typically contains the subscription related information for users (and enterprises as desired) which is used by other network entities for such activities such as registration with the IMS network 302. Additionally, the HSS 802 is in communications with the S-CSCF 310 and the I-CSCF 804. All of the three CSCFs shown in FIG. 8 are able to communicate with the IBCF 314 which provides border control functions. Virtual Private Network Routing Function (VPN-RF) 806, which is part of the serving operator network, can be, for example, an IMS application server, has access to the enterprise network access point repository (described below) and is capable of implementing various exemplary embodiments described herein. Additionally, VPN-RF 806 is capable of receiving a terminating session, routing session(s) across a serving operator network to the correct egress point of the serving operator network, e.g., an IBCF 314. Other nodes than those shown in FIG. 8 can be used within the IMS network 302 and more information pertaining to IMS networks in general can be found in both 3GPP TS 23.002 version 8.3.0 Release 8 and 3GPP TS 23.228 version 8.6.0 Release 8. Also, the nodes shown in FIG. 8 can be used to greater or lesser degrees in the exemplary embodiments described herein as seen below in, for example, the peering interconnection and subscription interconnection embodiments.

According to exemplary embodiments, an enterprise network can have multiple enterprise network access points. Different users within an enterprise can be associated with different enterprise network access points according to the desires of the enterprise. Information about different users within an enterprise and their association with an enterprise network access point, can be stored in a database or other desired storage location(s), such that the information is retrievable and accessible by both the enterprise and the serving network. For the different scenarios relating to how the enterprise and its users are connected to the serving operator network, different methods of making this information available can be used. For example, by allowing a particular level of access between their respective secure storage locations, which store this user contact information, both the serving network and the enterprise can have access to this information.

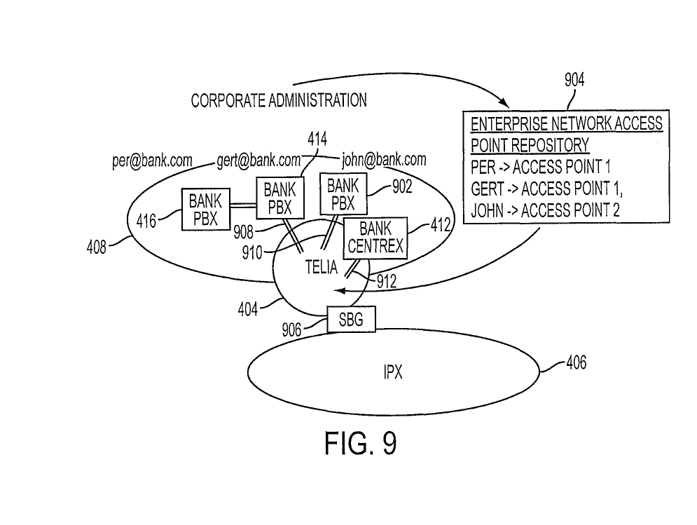

According to exemplary embodiments, in the case of the business trunking NGCN, the enterprise can populate a database, e.g., an enterprise network access point repository, with the enterprise network access point information for each user. This enterprise network access point repository could either be a part of an enterprise network to which the serving network has access or be part of a serving network to which an enterprise has access. However in the case of users who are using a hosted enterprise NGCN, e.g., a centrex, the enterprise would not typically need to populate an additional database with such information because the information would typically be provided in each user's entry in the HSS 802 of the serving network, i.e., there will be an IMS user for each enterprise user. Either way, the enterprise can populate a database as needed since the enterprise knows which enterprise network access points it has associated with its users as will be described in more detail below with respect to FIG. 9.

According to exemplary embodiments, FIG. 9 shows a serving operator network, e.g., Telia 404, in communication with the enterprise Bank's network 408, a plurality of enterprise network access points 908, 910 and 912, and an enterprise network access point repository 904 for determining which enterprise network access point should be used for forwarding communications to the various users within Bank 408. As can be seen in FIG. 9, Telia 404 has three enterprise network access points 908, 910 and 912 with Bank 408. Enterprise network access point 908 is used for traffic going to users at Bank PBX 414 and Bank PBX 416, e.g., gert@bank.com and per@bank.com respectively. Enterprise network access point 910 is used for traffic going to users at Bank PBX 902, e.g., john@bank.com, and Enterprise network access point 912 is used for traffic going to the Bank Centrex 412.

Using this exemplary communications architecture, the process for identifying the desired enterprise network access point can occur through the following steps. Initially, the enterprise's administration sets the policies and user locations. It then updates the enterprise network access point repository 904 so this information can be accessed by the serving network. An incoming call arrives at the serving operator network and is identified as being for a VPN service by, for example, the use of an IMS public service identity (PSI), as shown by VPN RF 806 in FIG. 8. The serving operator network obtains the original SIP URI from the received call and uses it to query the enterprise network access point repository. A response from the enterprise network access point repository 904 includes the identity of the enterprise network access point to be used.

Using this exemplary architecture and process for identifying the enterprise network access point, an exemplary use case according to an exemplary embodiment based upon FIG. 9 will now be described. Initially, a SIP message transits through the IPX 406 and then through SBG 906 to Telia 404. Telia 404 reads the message, which includes “INVITE sip:bankvpn@telia.se” and “Target sip:gert@bank.com” (as embedded in the SIP message according to exemplary embodiments described above), and queries the enterprise network access point repository 904 using “gert@bank.com”. The enterprise network access point repository 904 returns with the response which includes the association of gert with access point 1, which is enterprise network access point 908 in FIG. 9. The SIP message is then forwarded to gert@bank.com via the enterprise network access point 910.

According to exemplary embodiments, once the enterprise network access point has been identified, the call is routed across the serving IMS network 302 to the identified interconnection point with the enterprise network. Also, the serving operator network typically has configuration data that identifies, for each enterprise network access point, whether the access point is a subscription interconnection or a peering interconnection. This information is useful since different nodes within the IMS network 302 are typically used in the delivery process depending upon the interconnection type.

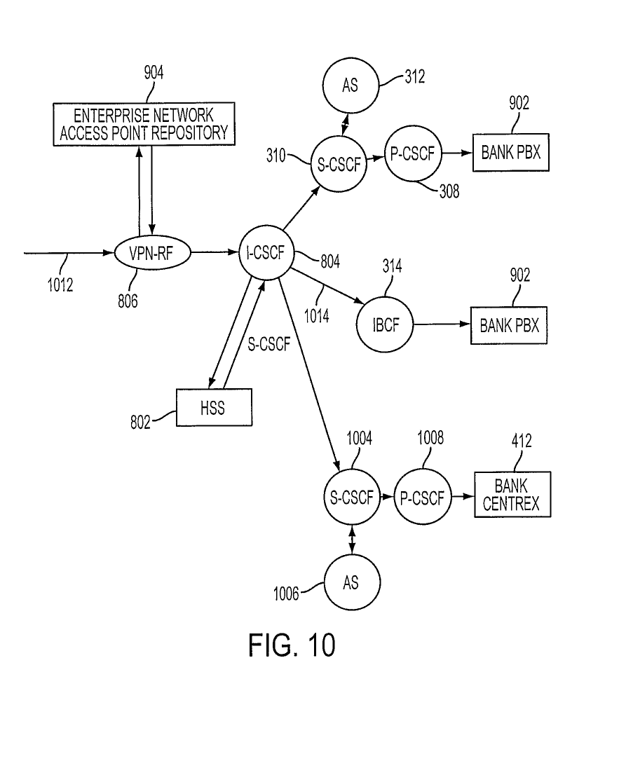

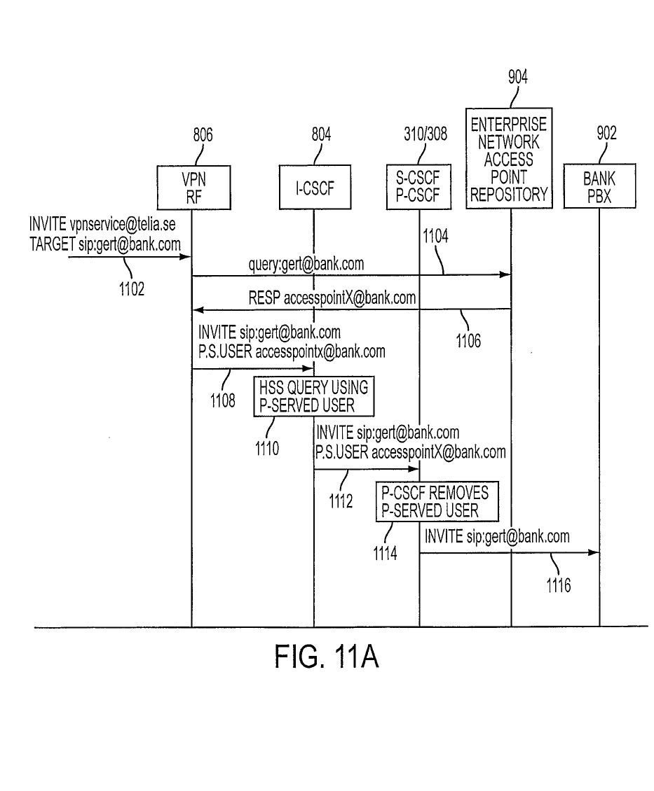

According to exemplary embodiments, if the enterprise network uses a peering interconnection, then the associated information in the enterprise network access point repository 904 will identify the IBCF 314 to be used. Using the exemplary network nodes shown in FIG. 10, an example of routing for a peering interconnection will now be described. Initially, a VPN-RF 806 receives a message 1012 which includes in the SIP message “VPNservice@telia.com” and “Target=john@bank.com”. The VPN-RF 806 then queries the enterprise network access point repository 904 with “john@bank.com” and receives a response which includes the enterprise network access point associated with john, e.g., “accesspointX@bank.com”, as well as the identity of the IBCF 314 at the edge of the serving network which handles this peering interconnect. The VPN-RF 806 will then place the enterprise network access point information into the P-Served-User header and place the IBCF 314 identity into the SIP route header of the message to be routed. As will be appreciated by those skilled in the art, the P-Served User header is a header field which can be added to initial requests routed from an S-CSCF 310 to an AS 312 or from and AS 312 to an S-CSCF 310 and which typically contains the IMS Public User Identity of the user that is served by the S-CSCF 310 and on whose behalf an application is invoked. The P-Served User header can include a session case parameter, which may be used to convey whether the initial request is originated by or destined for the served user. The P-Served User header can also include a registration state parameter which may be used by the S-CSCF 310 towards an AS 312 to indicate whether the initial request is for a registered or an unregistered user. Normal IMS routing procedures based upon DNS and SIP route headers can be used to deliver the call to the correct IBCF 314.

For example, a message is forwarded through the IMS network 302 to IBCF 314, with the message including “john@bank.com”, information identifying the IBCF 314 in the SIP route header and “route=accesspointX@bank.com” in the P-Served-User header. The IBCF 314 will then analyze the P-Served-User header information to determine which enterprise network access point the message is to be delivered to. Prior to forwarding the message, the IBCF 314 will delete the P-Served-User header. Additionally, the IBCF 314 can apply any pre-determined policy decisions as desired. In this example, the message is forwarded through the identified enterprise network access point to Bank PBX 902.

According to exemplary embodiments, if the enterprise network uses a subscription interconnect then the enterprise network access point data in the database will identify the IMS user representing the enterprise network access point of the NGCN. Using the exemplary network nodes in FIG. 10, an example of call routing using a subscription interconnection will now be described. Initially, a VPN-RF 806 receives a message 1012 which includes in the SIP message “VPNservice@telia.com” and “Target=john@bank.com”. The VPN-RF 806 then queries the enterprise network access point repository 904 with “john@bank.com” and receives a response which includes the enterprise network access point e.g., accesspointX@bank.com, and the identification of the I-CSCF 804 to be used. The VPN-RF 806 can then place the enterprise network access point information into the P-Served-User header. The VPN-RF 806 then delivers the call to I-CSCF 804 which queries the HSS 802 using the P-Served-User header as the query key, which responds with the S-CSCF 310 associated with the registered user. In this example, “accesspointX@bank.com” is the IMS user as provisioned in the HSS 802 whereas “john@bank.com” is the enterprise user. Multiple enterprise users can be located behind “accesspointX@bank.com”, with this knowledge of both the IMS user and the enterprise users (and their relationship) stored in the enterprise network access point repository 904.

For example, suppose that “accesspointX@bank.com” is in the P-Served-User header and is used by the I-CSCF 804 to query the HSS 802 which sends information that identifies the S-CSCF 310 as being associated with “accesspointX@bank.com”. The I-CSCF 804 can then forward the call to the appropriate S-CSCF 310. The S-CSCF 310 then can use the P-Served-User header as desired in the future. Also for future calls, normal terminating IMS procedures can be used to deliver the calls to AS 312 and P-CSCF 308. To complete this example, the S-CSCF 310 then forwards the call to the P-CSCF 308 which analyzes the P-Served-User header information, deletes the P-Served-User header information and then delivers the call to the access point X for distribution within the enterprise, e.g., the user john associated with Bank PBX 902 receives the message.

Also shown in FIG. 10 are S-CSCF 1004, P-SCSF 1008, AS 1006 and Bank Centrex 412. These nodes represent a subscription interconnect which ends in a virtual PBX, e.g., Bank Centrex 412. For the purpose of exemplary embodiments described herein, there are no discernable differences for one skilled in the art for the implementation of these exemplary embodiments for either typical PBXs or virtual PBXs since the serving network will have the information required to correctly deliver calls and messages.

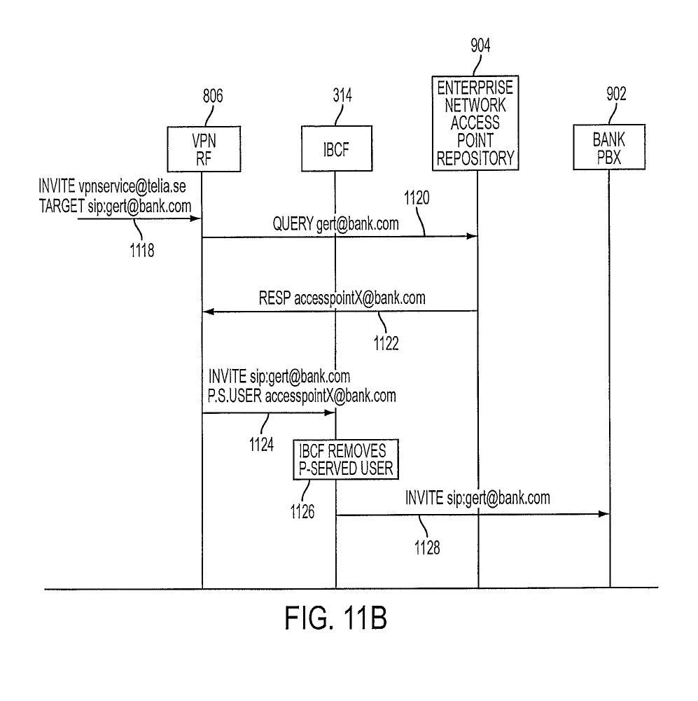

Using the exemplary architectures shown in FIG. 10, a signaling diagram for a subscription interconnect according to an exemplary embodiment will now be described with respect to FIG. 11(a). Initially, VPN-RF 806 receives a SIP INVITE message 1102 which includes “vpnservice@telia.se” and “Target sip:gert@bank.com”. The VPN-RF 806 then transmits a query message 1104, which includes the destination information gert@bank.com, to the enterprise network access point repository 904. The enterprise network access point repository 904 performs a lookup to determine the enterprise network access point and I-CSCF 804 associated with the destination user address in the query message 1104. This enterprise network access point information is returned to the VPN-RF 806 in the response message 1106. The VPN-RF 806 then embeds the enterprise network access point information into the P-Served-User header of the received SIP invite message and forwards the message 1108 to the I-CSCF 804.

Using the P-Server-User header information, the I-CSCF 804 queries, as shown by box 1110, the HSS 802 for the S-CSCF 310 associated with that enterprise network access point. The I-CSCF 804 then forwards the SIP INVITE message 1112 to the appropriate S-CSCF 310 and P-CSCF 308. Using the information in the P-Served-User header, the P-CSCF forwards the message 1116 to the correct user represented by Bank PBX 902 through the designated enterprise network access point, after removing the P-Served-User header from the SIP message.

Using the exemplary architectures shown in FIG. 10, a signaling diagram for a peering interconnect according to an exemplary embodiment will now be described with respect to FIG. 11(b). Initially, VPN-RF 806 receives a SIP INVITE message 1118 which includes “vpnservice@telia.se” and “Target sip:gert@bank.com”. The VPN-RF 806 then transmits a query message 1120 which includes the destination user address “gert@bank.com” to the enterprise network access point repository 904. The enterprise network access point repository performs a lookup to determine the enterprise network access point and IBCF 314 associated with the user (or destination) in the query message 1120. This enterprise network access point information is returned to the VPN-RF 806 in the response message 1122. The VPN-RF 806 then embeds the enterprise network access point information into the P-Served-User header of the received SIP INVITE message and forwards the message 1124 to the IBCF 314. The IBCF 314 reads the message 1124, and determines the enterprise network access point to use for the designated user. The IBCF 314 then removes the P-Served-User header 1126 and forwards the SIP INVITE as message 1228 to gert@bank.com via Bank PBX 902.

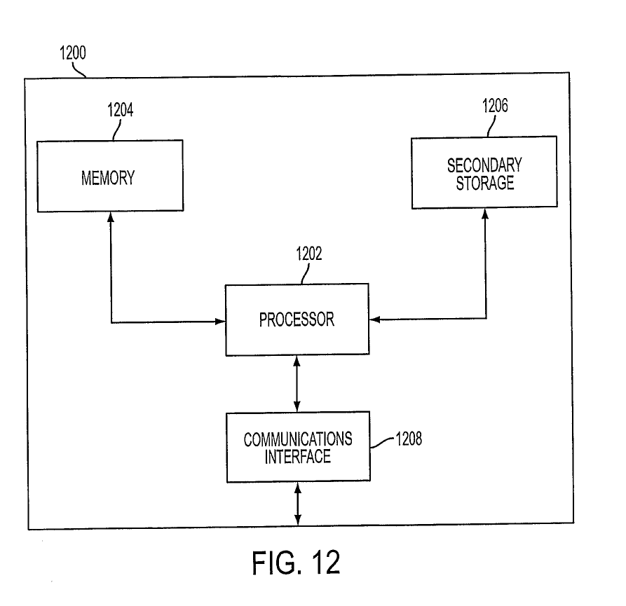

The exemplary embodiments described above describe methods and systems for using an enterprise network access point repository 904 to store enterprise network access point information that is matched to end users. An exemplary communications node 1200, which can act as an enterprise network access point repository 904 will now be described with respect to FIG. 12. Communications node 1200 can contain a processor 1202 (or multiple processor cores), memory 1204, one or more secondary storage devices 1206 and a communication interface 1208 to facilitate communications. The memory 1204 (or secondary storage devices 1206) can be used for storage of the information used in the access point table 904. Thus, a communications node 1200, according to exemplary embodiments, is capable of receiving a query and returning the enterprise network access point associated with the destination user address. Additionally, communications node 1200 is capable of performing functions of other nodes described above in the various communications networks, such as, the VPN-RF 806 and the HSS 802.

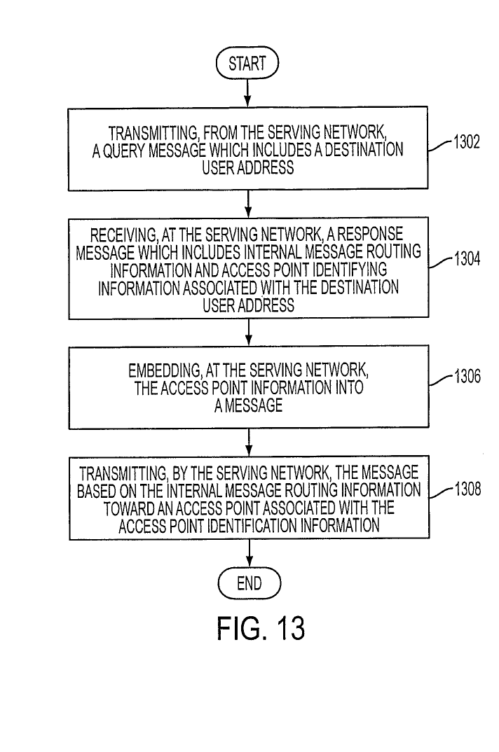

Utilizing the above-described exemplary systems according to exemplary embodiments, a method for routing message traffic is shown in the flowchart of FIG. 13. Initially a method for routing message traffic from a serving network to an enterprise network includes: transmitting, from the serving network, a query message which includes a destination user address in step 1302; receiving, at the serving network, a response message which includes internal message routing information and access point identifying information associated with the destination user address in step 1304; embedding, at the serving network, the access point information into a message in step 1306; and transmitting, by the serving network, the message based on the internal message routing information toward an access point associated with the access point identification information in step 1308.

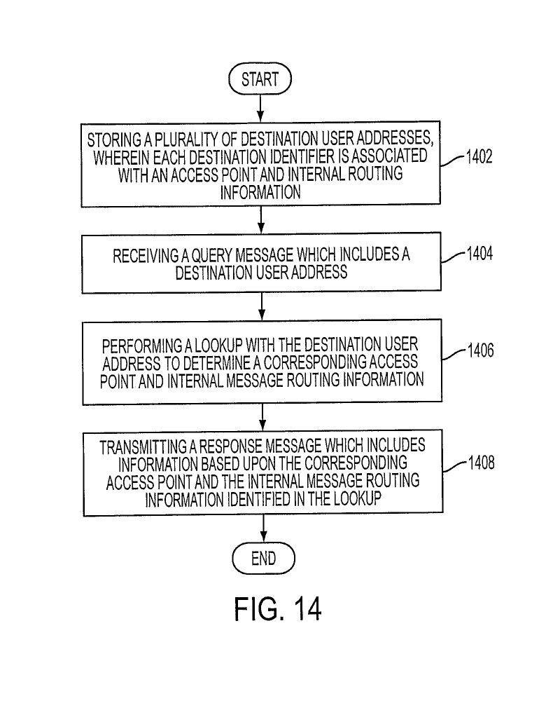

Utilizing the above-described exemplary systems according to exemplary embodiments, another method for routing message traffic is shown in the flowchart of FIG. 14. Initially a method for routing message traffic at a communications node includes: storing a plurality of destination user addresses, wherein each destination user address is associated with an access point and internal routing information in step 1402; receiving a query message which includes a destination user address in step 1404; performing a lookup with the destination user address to determine a corresponding access point and internal message routing information in step 1406; and transmitting a response message which includes information based upon the corresponding access point and the internal message routing information identified in the lookup in step 1408.

The above disclosed exemplary embodiments describe systems and methods associated with routing message traffic over interconnected networks. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

1. A method for routing communications from a serving network to an enterprise network comprising:
transmitting, from said serving network, a query message which includes a destination user address;
receiving, at said serving network, a response message which includes internal message routing information and access point identifying information associated with said destination user address;
embedding, at said serving network, said access point information into a message; and
transmitting, by said serving network, said message based on said internal message routing information toward an access point associated with said access point identification information.

2. The method of claim 1, wherein an interconnection between said serving network to said enterprise network is a subscription interconnection, and said step of transmitting, by said serving network, said message based on said internal message routing information toward an access point associated with said access point identification information further comprises:
transmitting said message based on said internal message routing information from a Virtual Private Network Routing Function (VPN-RF) to an interrogating call session control function (I-CSCF);
transmitting a query message from said I-CSCF, wherein said query includes access point identifying information associated with said destination user address;
performing a lookup using said access point information associated with said destination user address, wherein based upon said lookup a serving call session control function (S-CSCF) is identified;
transmitting said message to said identified S-CSCF;
forwarding said message from said S-CSCF to a proxy call session control function (P-CSCF);
removing said access point information associated with said destination user address by said P-CSCF; and
forwarding said message to said access point.

3. The method of claim 1, wherein an interconnection between said serving network to said enterprise network is a peering interconnection, and said step of transmitting, by said serving network, said message based on said internal message routing information toward an access point associated with said access point identification information further comprises:
transmitting said message based on said internal message routing information from a Virtual Private Network Routing Function (VPN-RF) to an interconnect border control function (IBCF);
removing said access point information associated with said destination identifier by said IBCF; and
forwarding said message to said access point.

4. The method of claim 1, wherein said message is a session initiation protocol (SIP) message.

5. The method of claim 2, wherein said access point information is embedded in a P-Served User Header in said message.

6. The method of claim 3, wherein said access point information is embedded in a P-Served User Header in said message.

7. The method of claim 2, wherein said internal message routing information identifies said I-CSCF for use and is embedded in a session initiation protocol (SIP) route header.

8. The method of claim 3, wherein said internal message routing information identifies said IBCF for use and is embedded in a SIP route header.

9. A method for routing communications at a communications node comprising:
storing a plurality of destination user addresses, wherein each destination user address is associated with an access point and internal routing information;
receiving a query message which includes a destination user address;
performing a lookup with said destination user address to determine a corresponding access point and internal message routing information; and
transmitting a response message which includes information based upon said corresponding access point and said internal message routing information identified in said lookup.

10. The method of claim 9, wherein said destination user addresses are SIP uniform resource identifiers (URIs).

11. The method of claim 10, further comprising:
receiving message updates when information said destination user addresses are added, deleted or moved; and
storing said updated information.

12. The method of claim 9, wherein said communications node is a database.

13. A communications node comprising:
a memory for storing destination user addresses, access point information and internal message routing information;
a communications interface for transmitting and receiving messages associated with said destination user addresses, access point information and internal message routing information; and
a processor for performing a lookup when a query including said destination user address is received, wherein said lookup results in return of said access point information and said internal message routing information, further wherein said communications interface transmits a response message including said access point information and said internal message routing information.

14. The communications node of claim 13, wherein said communications node is a database.

15. The communications node of claim 14, wherein said database is located within an enterprise.

16. The communications node of claim 14, wherein said database is located in a serving operator network.

17. The communications node of claim 16, wherein said serving operator network is an Internet Protocol Multimedia Subsystem (IMS) network.
